(19) United States
(12) Patent Application Publication
(10) Pub. No.: US 2024/0239693 A1
(43) Pub. Date: Jul. 18, 2024

(54) ELECTROCHEMICAL DEVICE FOR TREATING WATER

(71) Applicants: TREELIUM SA, Switzerland (CH); Alchim di Masante & C. S.a.s., Chieri (IT)

(72) Inventors: Roberto BARILLA, Chieri (IT); Roberto MASANTE, Chieri (IT); Paolo Lorenzo RICCARDINO, Chieri (IT); Andrea CARAVELLI, Mendrisio (CH)

(21) Appl. No.: 18/559,374

(22) PCT Filed: May 9, 2022
(86) PCT No.: PCT/IB2022/054276

§ 371 Date: Nov. 7, 2023

(30) Foreign Application Priority Data
May 10, 2021 (IT) 102021000011924

(51) Int. Cl. C02F 1/46; A23F 5/26; A47J 31/40; A47J 31/60; C02F 1/461; C02F 1/52; C02F 101/20; C02F 103/02

(52) U.S. Cl. CPC C02F 1/4602; A23F 5/262; A47J 31/407; A47J 31/605; C02F 1/4618; C02F 1/52; C02F 2001/5218; C02F 2101/20; C02F 2103/02; C02F 2201/46115; C02F 2201/4613; C02F 2307/10

(57) ABSTRACT

An electrochemical water softening device is described comprising a containment module where bicarbonates are removed by solid-phase precipitation in a basic environment and by conversion into carbon dioxide in an acidic environment.

### FIELD OF APPLICATION

The present invention relates to a water treatment device suitable for the removal of alkaline-earth and heavy metals as well as for water softening.

### PRIOR ART

The need to treat water for softening and for removing alkaline-earth metals is felt both in the industrial field and in the field of small appliances for domestic use.

As known the hardness of water expresses the total content of calcium and magnesium ions due to the presence of dissolved salts. The total hardness is the sum of the temporary hardness, which expresses the amount of hydrogen carbonates (or bicarbonates) present in the water, with the permanent hardness also known as fixed residue.

The process of reducing the hardness of water is known as softening process. It is well known that hard water tends to cause scaling phenomena which are detrimental to the appliances used in particular in domestic environments. For this reason softening devices are used which are essentially designed to remove all the salts dissolved in water to reduce the total hardness.

Referring in particular to the domestic sector in recent years there has been a surge in the development of machines for the preparation of coffee or other beverages starting from pods or capsules. This development has been accompanied by an improvement in the quality of beverages obtainable with these machines. In the past and referring in particular to the coffee sector such machines used to produce mediocre coffee; nowadays, on the contrary, the presently available coffee machines can be used to prepare a high-quality coffee similar to the one prepared in a bar and high-quality coffee pods or capsules are available. However, it is well known that the quality of the water itself is an important factor in the preparation of an excellent coffee, and the quality of domestic water is not always satisfactory in this respect.

In addition modern coffee machines (or more generally machines for the preparation of beverages from pods, capsules or similar) typically comprise hot parts with very small water passage sections which make them exposed and vulnerable to scaling.

The use of demineralised water might appear to be a solution but it has been shown that demineralised water if on one hand protects the machine from scaling on the other it produces unsatisfactory coffee in terms of taste and aroma and it is also an additional cost.

It is also possible to use water as directly available and periodically clean the machine but the latter task is bothersome and it requires the use of products that are generally unpleasant to the consumer as they are toxic or otherwise capable of contaminating the coffee. After all, installing water softening devices in coffee machines is not always feasible especially in small-sized domestic machines. It is therefore evident that the problem of water quality in the field of coffee machines has not yet been adequately solved.

For similar reasons the problem of water hardness is also felt in other applications such as in the household appliances sector, in vending machines, etc.

### SUMMARY OF THE INVENTION

The object of the present invention is to provide an innovative system for the removal of alkaline-earth and heavy metals and for water softening.

The objects are achieved by a device and a process according to the claims. Preferred embodiments are the subject-matter of dependent claims.

One of the aspects of the invention is a water softening process comprising: subjecting the water to be treated to one or more of an increase in temperature, a change in pressure and a change in pH; contacting the water subjected to said temperature or pressure or pH variation with a limescale trap, in which said limescale trap comprises or consists of a fabric element, preferably in cotton, which is preloaded with limestone crystals, and in which the preloading of said trap is obtained by subjecting said fabric element to a bath in calcareous water and subsequent drying.

In a preferred embodiment the process is of the electrochemical type.

The device according to the invention makes it possible to implement an electrochemical process in two separate environments, one acidic and the other basic, which only eliminates the temporary hardness. The elimination of temporary hardness essentially takes place in accordance with the following reactions:

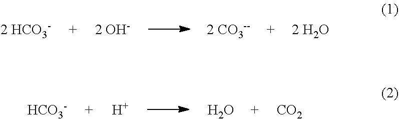

The reaction (1) takes place in a basic environment by precipitating limescale and trapping it in a suitable filter: this operation can be carried out in a basic environment where the presence of OH causes soluble bicarbonates to precipitate into insoluble carbonates. The latter, once precipitated, can be collected inside a suitable filter.

The reaction (2), on the other hand, takes place in an acidic environment where the presence of H⁺ ions causes the bicarbonates to separate into water and carbon dioxide. By eliminating alkalinity, the anionic part that causes limescale formation is effectively eliminated.

More specifically, the following reactions take place in a device according to the invention.

Reactions to the cathode:

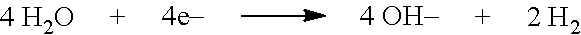

Reactions to the anode:

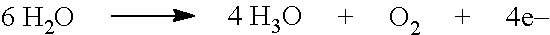

Reactions in the anodic chamber:

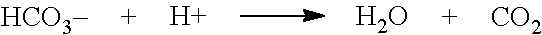

Reactions in the cathodic chamber:

Ca(HCO₃)₂+Ca(OH)₂→2CaCO₃+2H₂O with precipitation of calcium carbonate.

Water undergoes a weak electrolysis creating an acidic area (anodic chamber) that eliminates alkalinity and a basic area (cathodic chamber) that precipitates limescale. Limescale can be deposited on the trap that is provided in the cathodic chamber. The two streams of water that cross the anodic chamber and the cathodic chamber are advantageously reunited at the outlet, restoring the original pH without residual temporary hardness.

One of the innovative aspects of the present invention is represented by the limescale trap that is placed inside the cathodic chamber. Said limescale trap is adapted to facilitate the formation of crystals by acting as a growth centre and retaining the precipitate. One of the aspects of the invention consists in favouring the growth of crystals over the formation of new crystals, which is more energy-efficient. The limescale trap in some embodiments can be pre-loaded with crystals adapted to provide nuclei for the growth process.

The device of the invention can be made for both industrial and for domestic use. In particular, the device lends itself to being manufactured with small dimensions therefore finding application in the domestic environment.

A particularly interesting (though not limiting) application of the invention relates to the treatment of water used in coffee machines or more generally for the preparation of beverages. The elimination of the temporary hardness, but not of the permanent one, means that calcium and magnesium remain in the water which allows to obtain a coffee of superior quality in terms of taste and cream. The invention makes it possible to eliminate or inhibit the scaling of the appliances caused by the portion of the temporary hardness (bicarbonates of calcium and magnesium) while keeping in solution the salts that do not cause scaling and which give a “taste” to the water and make it possible to prepare a coffee with an intense aroma.

The device according to the invention can be advantageously placed “inline” so as to directly treat the water before use. In particular, the device is suitable to equip modern coffee machines for domestic use; similarly it can be used for example in vending machines or in household appliances, for instance in a dishwasher. Another interesting field of application is the production of ice at home.

Another and not negligible advantage is given by the low cost and small footprint which allows the device to be installed as standard equipment or even retro-fitted in a wide range of appliances.

Another aspect of the invention is a machine for preparing coffee or other beverages at home or a vending machine equipped with the above-described device for treating the water intended for preparing coffee or other beverages.

Still another aspect of the invention is a corresponding method for preparing coffee or other beverages in a domestic machine or vending machine.

It should be noted that the domestic and small appliance sector represents an interesting application of the invention which however should not be understood as limiting. The device of the invention can be realised on any scale and will therefore also find application in the industrial field for the treatment of significant amounts of water.

A water treatment process according to the claims is also an object of the invention.

### DESCRIPTION OF PREFERRED EMBODIMENTS

A device according to the invention comprises at least a first electrode and a second electrode arranged to cause electrolysis of water contained in the treatment chamber; a separating mean arranged to divide the treatment volume into at least two chambers which include a first chamber containing the first electrode and a second chamber containing the second electrode.

In use the first electrode and the second electrode are polarized with opposite sign. The device may comprise appropriate polarization means for this purpose. The polarization of the electrodes creates an anodic chamber and a cathodic chamber.

The electrodes are metal electrodes made of suitable material such as stainless steel, platinum or more preferably titanium or graphite.

The device also has at least one limescale trap which is placed inside the chamber intended to act as a cathodic chamber. This limescale trap is adapted to capture the limescale precipitated in the chamber as a result of the treatment.

The separating mean may include a porous septum, a cationic membrane (which only allows positive ions to cross it) or an anionic membrane (which only allows negative ions to cross it).

The limescale trap can be realised as a filtration system with a high specific surface area. Advantageously, limescale crystallization nuclei are previously deposited on said filtration system; inside the cathodic (basic) chamber the filtration causes the carbonate that precipitates (based on the chemical reactions already seen) to enlarge the nuclei and remain trapped inside them.

The crystallization process essentially involves two phases: nucleation and growth. Nucleation is the formation of a very small crystal which already possesses the definitive form or crystal habit; growth is the progressive formation of a larger crystal.

The nucleation phase is more energetically demanding than the growing phase so that when crystallization nuclei are present the process tends to increase existing nuclei rather than to create new nuclei. The limescale trap represents a filtering system with a high specific surface area on which limescale crystallization nuclei can be deposited in advance; inside the cathodic (basic) chamber the filter causes the precipitating carbonate (based on the chemical reactions already seen) to enlarge the nuclei and remaining trapped inside it.

In a preferred embodiment the device comprises a respective limescale trap in each of the two chambers thus being symmetric in that each of the two chambers can operate both as a cathodic chamber and as an anodic chamber.

The advantage of the symmetric realisation is the possibility of providing a cleaning cycle of the trap without interrupting the operation. The trap has a saturation point beyond which it is no longer able to retain limescale however, by virtue of the symmetry of the device it is possible to cyclically reverse the polarity of the electrodes and carry out an appropriate washing cycle during which the trap is in an acidic chamber and is regenerated. By reversing the polarity, the traps rotate so as to be in a basic environment where the limescale is trapped and in an acidic environment where the previously trapped limescale is regenerated.

It should be noted that the regeneration of the limescale trap is carried out without using chemicals that are harmful to the environment or to the humans, which is an important advantage especially if the device is used to treat drinking water or water intended for preparing a beverage.

The limescale trap can be fixed or replaceable. A non-replaceable trap may simplify the construction and is preferably used in smaller devices; a replaceable trap is particularly advantageous for devices of considerable size and when a significant amount of water is handled.

The separating mean may comprise a porous septum or a cationic membrane or an anionic membrane.

The device can comprise cationic and anionic resins in at least one of the chambers, said resins being suitable for retaining ions and releasing hydrogen or hydroxyls to water. Such embodiment improves efficiency and can be preferred in case of particularly hard water.

It is known that cationic and anionic resins are able to retain ions producing demineralized water. These resins retain ions and release hydrogen or hydroxyls (OH—) to water and when saturated they must be counter-washed with strong acids or bases in order to restore their function. In the invention, in addition to exploiting the trap (described above), resins are exploited in a mixed bed (anionic, cationic) in order to increase the yield of the system.

More advantageously, the resins are used in a symmetric device as described above. In this case, the resins that are alternated in an acidic or basic environment are continuously regenerated.

Another embodiment of the invention is represented by a double membrane anionic and cationic system. The result is a three-chamber system where two chambers behave like the system described above and the third chamber collects almost completely demineralised water. In the central chamber this result is obtained precisely because the membranes are selective towards positive and negative ions. Preferably, said third chamber is in a central position while the other two are in the peripheral positions.

A further variant is represented by a multistage device allowing to have multiple stages in parallel to increase efficiency. The outermost electrodes can be selectively powered alternatively all the electrodes can be powered. A multistage device can also be provided with anionic and cationic membranes or anionic and cationic resins.

Advantageously a device according to the invention is powered by direct current. In a typical embodiment for a domestic device (such as a coffee machine) the maximum current in the device is approximately 100 mA and the maximum consumption is 2.4 W. It is therefore understood that the device of the invention is not only economical to be manufactured but is also economical in the consumption.

In a particular interesting embodiment, it is possible to combine the device of the present invention with a water activator installed upstream of the device.

The activator essentially comprises a conduit in which are provided with a series of fixed blades aligned along the direction of flow and rotated with respect to each other by a suitable angle. The advantage of the actuator is that it enhances the generation of limescale nuclei that will load the trap i.e. the need to pre-load the trap is avoided. Therefore, the activator works in synergy with the device. Said activator more advantageously is made as in EP 3 085 670 or as in EP 3 208 242.

The device and the method of the present invention can also be applied to the treatment of aqueous solutions.

Further aspects of the invention are the following.

It is known that bicarbonates change into insoluble carbonates (or limestone) following an increase in temperature, a change in pressure or a change in pH.

In particular, an increase in pH allows the carbonates to precipitate at room temperature; in fact in the past to soften the waters, the waters were treated with calcium hydroxide (basic) in order to separate the carbonates of Ca and Mg.

In the electrolytic process, in addition to the production of gas (O₂ and H₂), chemical changes are produced near the electrodes, in particular water rich in OH⁻ ions is obtained on one electrode (basic) and H⁺ ions (acid) on the other electrode. Limestone precipitation occurs near the electrode in which the water is basic.

The present invention uses the limestone trap which allows limestone to be captured as it forms.

In a particularly preferred embodiment, the limestone trap comprises or consists of an element or body made of fabric, preferably of cotton, which has previously been soaked in calcareous water at high temperature and then dried. This operation allows you to create small crystals and nuclei that remain stationary on the fabric.

It should be noted that a crystallization process is divided into two phases: nucleation (creation of small nuclei that already have the crystalline habit of the crystal) and growth in crystals. In a situation where nuclei are already deposited on the fabric trap, said nuclei act as a growth center as the limestone is formed by basification of the water and crystallization is completed with the growth phase. The result is that all the crystallization takes place on the fabric trap which by its structure retains all the limestone inside.

This trap-based system can be used on all occasions in which limestone tends to precipitate or to form therefore in any of the three cases mentioned; in particular, this system can also be used in a boiler in which the water is heated.

The choice for small and medium filters to use the electrolytic process has some advantages: it is not necessary to heat the water, there is a low consumption of electrical power, there is a recovery of hydrogen with the possibility of generating electricity.

In particular, the electrolysis process produces hydrogen that can be easily conveyed to a fuel cell that is able to convert it into electric current in order to partially recover the energy needed in the process itself.

The electrolysis filter can also be used with demineralization resins. These resins are used to demineralize water and must be regenerated with acidic and basic substances. In some forms of the invention, the electrolysis process is used only in the regeneration phase because H+ and OH− ions are produced which are useful for regeneration. In this case, the trap prevents limescale from settling on the electrode during the regeneration phase.

A process according to the invention can also be used in a hot water boiler.

### DESCRIPTION OF THE FIGURES

FIGS. 1-5 represent a water softening device according to some embodiments of the present invention.

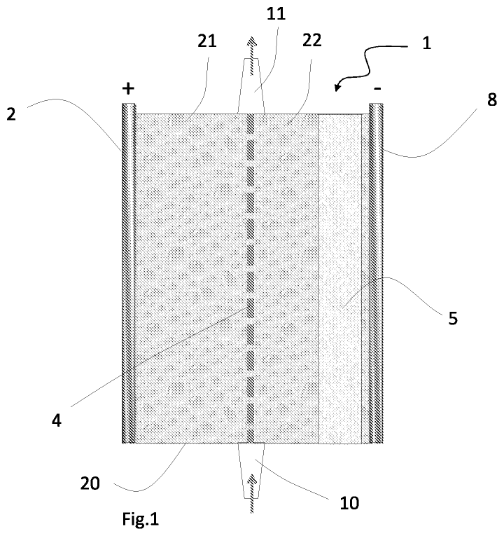

In FIG. 1 1 is represented a softening device comprising an inlet conduit 10, an outlet conduit 11 and a containment body or module 20 defining a water treatment volume.

The body 20 is for instance essentially a cylinder with an appropriate diameter depending on the application of the device.

Said containment module 20 is delimited on the sides by a positive electrode 2 and by a negative electrode 8. A separating septum 4 is provided essentially along the centreline of the device 1 and defines within the body 20 a first chamber 21 and a second chamber 22. The chambers 21 and 22 are essentially delimited between the central septum 4 and the electrodes 2, 8 respectively. The second chamber 22 also contains a limescale trap 5 represented by a filter body pre-loaded with limescale nuclei.

The water entering the device from the conduit 10 is distributed between the two chambers 21 and 22. In the first chamber 21, an acidic or slightly acidic pH is established and the bicarbonates are removed by conversion into carbon dioxide; in the second chamber 22, a basic or slightly basic pH is created and the bicarbonates are removed by solid-phase precipitation on the limescale trap 5. The neutrality of the aqueous solution is restored in the outlet conduit 11 where the water streams passing through the chambers 21 and 22 are reunited.

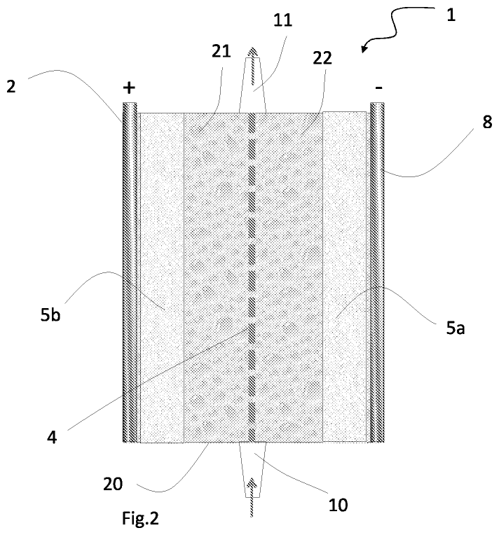

In FIG. 2 an example of a softening device with a symmetric configuration is represented. In this configuration both the first chamber 21 and the second chamber 22 contain a respective limescale trap 5a, 5b. This configuration allows the limescale trap 5a or 5b to be regenerated in situ by reversing the polarization of the two electrodes.

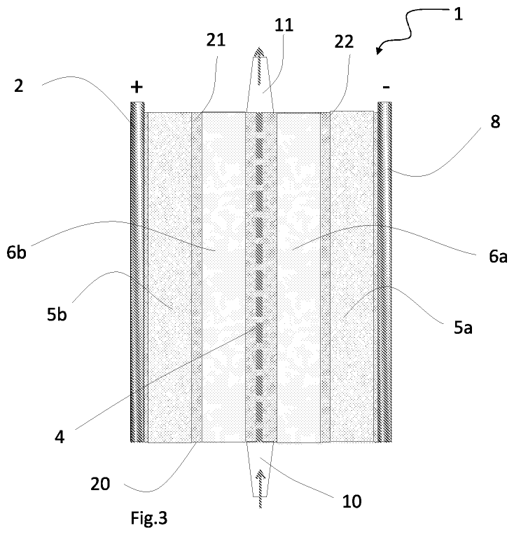

In FIG. 3 a symmetric device is represented as in FIG. 2 further comprising two cationic/anionic mixed bed resins 6a, 6b that allow to increase the yield of the system.

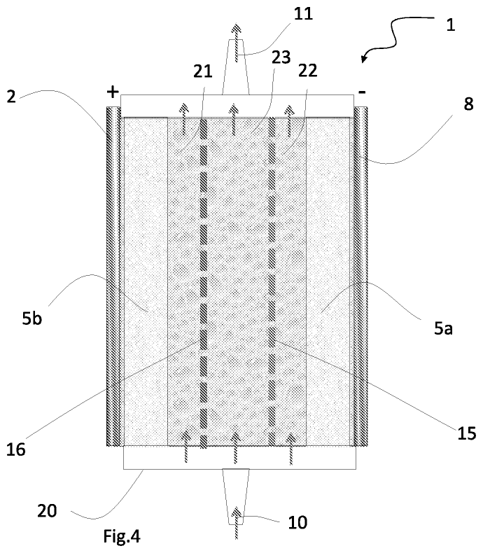

In FIG. 4 a softening device is represented in the double membrane embodiment. The device comprises an anionic membrane 16 and a cationic membrane 15. Three chambers 21, 22, 23 are thus defined where the peripheral chambers 21 and 22 behave like in the device of FIG. 2 while the central chamber 23 is substantially crossed by demineralised water.

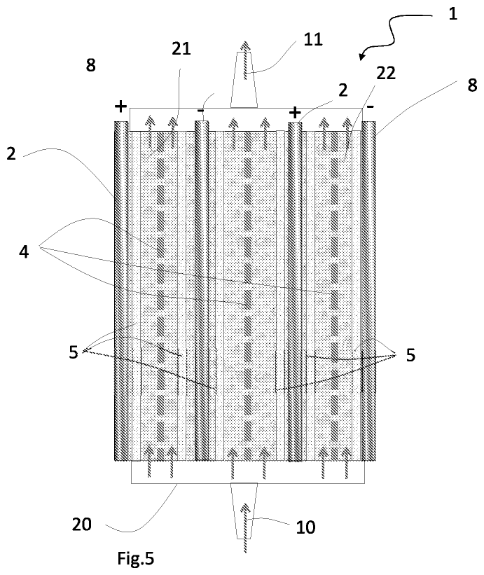

In FIG. 5 is represented a multistage softening device provided with multiple modules in parallel which are configured to increase the efficiency of the system. Each of the modules can be realised according to the variants described above and in the illustrated example each module comprises two traps. In FIG. 5 the traps 5 and the separating septum 4 of each module are indicated.

1-25. (canceled)

26. A water treatment device for metal removal and for water softening, the water treatment device comprising:
an inlet connection for the water to be treated;
an outlet connection for the treated water;
a body delimiting on the inside a treatment volume in fluid communication with said inlet and outlet connections;
at least a first electrode and a second electrode arranged to cause electrolysis of the water contained in the treatment volume;
at least one separating means arranged to divide said treatment volume into at least two chambers that include a first chamber containing said first electrode and a second chamber containing said second electrode;
wherein both the first chamber and the second chamber include an inlet and an outlet for the water, in which the inlet of each of the first and second chambers is in communication with said inlet connection of the water treatment device, so that the incoming water in the water treatment device can flow in parallel in the at least two chambers;
wherein, in use, one of said first and second electrodes is positively polarizable so that the corresponding chamber operates as an anodic chamber, and the other of the first and second electrodes is negatively polarizable so that the corresponding chamber operates as a cathodic chamber; and
at least one limescale trap that is placed inside the cathodic chamber and is adapted to capture the limescale precipitated in said chamber as a result of the treatment.

27. The water treatment device according to claim 26, wherein said limescale trap is adapted to facilitate, during operation, formation of crystals by acting as a growth center and is adapted to retain the precipitate.

28. The water treatment device according to claim 26, wherein said limescale trap comprises a filter body.

29. The water treatment device according to claim 28, wherein the filter body of the limescale trap is pre-loaded with limescale crystals.

30. The water treatment device according to claim 26, wherein the limestone trap comprises a fabric element.

31. The water treatment device according to claim 30, wherein said fabric element is preloaded with limestone crystals by a bath in limestone water and subsequent drying.

32. The water treatment device according to claim 26, further comprising a respective limescale trap in each of the at least two chambers so that the water treatment device is symmetric and each of the at least two chambers is operable either as a cathodic chamber or as an anodic chamber.

33. The water treatment device according to claim 32, further comprising means for reversing the polarity of said first and second electrodes, thus being able to alternatively use one of the at least two chambers as a cathodic chamber for trapping the limescale in a basic environment wherein the limescale is accumulated in the respective trap, and the other of the at least two chambers as a washing anodic chamber in an acidic environment wherein the accumulated limescale is removed from the respective trap.

34. The water treatment device according to claim 26, wherein said separating means comprises a porous septum or a cationic membrane or an anionic membrane.

35. The water treatment device according to claim 26, further comprising cationic and anionic resins in at least one of the chambers, said cationic and anionic resins being suitable for retaining ions and releasing hydrogen or hydroxyls to water.

36. The water treatment device according to claim 26, further comprising an anionic membrane and a cationic membrane which are selective respectively towards the passage of negative and positive ions, said anionic membrane and said cationic membrane are arranged to define three chambers within the treatment volume, including said anodic and cathodic chambers and a third chamber for collecting demineralised water.

37. The water treatment device according to claim 26, arranged to mix the flow of water exiting said the at least two chambers before passing into the outlet connection.

38. A device, comprising:
a plurality of stages in parallel, each of the plurality of stages comprising:
a respective treatment volume;
a respective pair of electrodes;
a separating means;
a limescale trap; and
optionally anionic and cationic membranes or anionic and cationic resins; all according to claim 26.

39. A water treatment system, comprising:
a water treatment device according to claim 26;
a water activator placed upstream of the treatment device in such a way that the treatment device is supplied with water subjected to pass through said activator; wherein the activator comprises:
a conduit crossed by the flow of water; and
a series of fixed blades contained in said body and aligned along the direction of flow and rotated with respect to each other.

40. A machine or dispenser for preparing beverages, the machine of dispenser comprising: the water treatment device according to claim 26.

41. A method for preparing a beverage in a domestic machine or in a dispenser, comprising:
using water treated with the water treatment device according to claim 26.

42. The method according to claim 41, wherein the beverage is prepared using a pod or capsule, and the beverage is coffee.

43. A water softening process performed in the water treatment device according to claim 26, the water softening process comprising:
supplying water to be treated to the first chamber and to the second chamber of the water treatment device;
polarizing said first electrode and said second electrode by establishing a potential difference between the two electrodes;
establishing an acidic or slightly acidic pH environment in the first chamber and a basic or slightly basic pH environment in the second chamber;
in the first chamber, converting bicarbonates dissolved in water into carbon dioxide;
in the second chamber, obtaining a solid-phase precipitation of bicarbonates dissolved in water with retention of the precipitate in said trap; and
mixing the flow exiting said first chamber and the flow exiting said second chamber thus obtaining a flow of treated water.

44. The water treatment process according to claim 43, wherein in the second chamber on the limescale trap an increase of crystallization nuclei takes place due to the precipitation and retention of the crystals formed by growth inside the trap.

45. The water treatment process according to claim 44, wherein growth of the crystallization nuclei is predominant over the formation of new crystals.

46. The water treatment process according to claim 44, wherein the growth process takes place on nuclei that are pre-loaded on a filtering surface of the limescale trap.

47. The water treatment process according to claim 46, wherein the filtering surface is a surface of a fabric element, which has been preloaded with limestone crystals through a bath in calcareous water and subsequent drying.

48. The water treatment process according to claim 43, further comprising producing hydrogen following the electrolysis of water.

49. The water treatment process according to claim 48, further comprising producing electricity from hydrogen thus obtained.

50. A water softening process, comprising:
subjecting the water to be treated to one or more of an increase in temperature, a change in pressure, or a change in pH; and
contacting the water subjected to said temperature or pressure or pH variation with a limescale trap, in which said limescale trap includes of a fabric element, which is preloaded with limestone crystals, and in which the preloading of said limescale trap is obtained by subjecting said fabric element to a bath in calcareous water and subsequent drying.
